(19) United States
(12) Patent Application Publication
(10) Pub. No.: US 2007/0274321 A1
(43) Pub. Date: Nov. 29, 2007

(54) Vlan Mapping For Multi-Service Provisioning

(76) Inventors: Ulf Fredrik Jonsson, Solna (SE); Wei Zhao, Stockholm (SE); Vicknesan Ayadurai, Sollentuna (SE)

Correspondence Address: ERICSSON INC., 6300 LEGACY DRIVE, M/S EVR 1-C-11, PLANO, TX, 75024, US

(21) Appl. No.: 10/598,945

(22) PCT Filed: Mar. 17, 2004
(86) PCT No.: PCT/EP04/02754

§ 371 Date: Mar. 9, 2007

(30) Foreign Application Priority Data
Mar. 17, 2004 (EP) 04821441-5

(51) Int. Cl. H04L 12/00

(52) U.S. Cl. 370/395.53

(57) ABSTRACT

A Virtual Local Area Network, VLAN, Mapping Point enables an end user to simultaneously access multiple services through a single broadband connection. The VLAN Mapping Point is implemented at a border between first and second independently tagged VLAN regions, and includes a mapping function that receives traffic packets from each of the VLAN regions, maps VLAN tags in the packets to associated VLAN tags for the other VLAN region, and forwards the packets using the associated VLAN tags. The first VLAN region may be a last-mile network that connects to end users. and the second VLAN region may be an aggregation network that connects to a core network.

### BACKGROUND OF THE INVENTION

1. Technical Field of the Invention

The present invention relates generally to digital communication systems. More particularly, and not by way of limitation, the invention is directed to an apparatus and method for mapping Virtual Local Area Networks (VLANs) to end users and services when an end user accesses multiple services over a single broadband connection.

2. Description of Related Art

Ethernet is a packet-based transmission protocol that is primarily used in local area networks (LANs). Ethernet is the common name for the IEEE 802.3 industry standard. Data is transmitted in Ethernet frames, the structure of which is defined in the IEEE 802.3 standard. In addition, a VLAN ID field is specified in the IEEE802.1Q standard. The IEEE 802.3 standard and the IEEE802.1Q standard are incorporated herein by reference.

It is desirable for residential end users connected to broadband access networks to have access to multiple services. For example, if an end user has two PCs at home, he should be able to use one PC to surf the Internet while using the other PC to connect to his corporate network. The two PCs may have different IP address domains and different requirements to the network when it comes to parameters such as Quality of Service (QoS) and Security, but they are connected via the same broadband access network.

To achieve this goal, the broadband access network must separate traffic from different services in the network. For example, Internet surfing and Voice over IP (VOIP) should be separated with different queues, QoS parameters, different dedicated bandwidth, and the like. The broadband access network must also separate traffic to and from different end users for the same service, so as to facilitate billing and traffic volume control.

One solution is a Public Ethernet solution that utilizes a technique referred to as a “service VLAN plus Mac Forced Forwarding” (i.e., VLAN+MacFF). In short, the residential broadband access is built with service VLANs (Internet access, VOIP, video, and so on), and traffic separation between end users is achieved with MacFF within each service VLAN. MacFF is a mechanism that ensures layer-2 separation of LAN stations accessing an IP gateway over a shared Ethernet segment. MacFF implements an Address Resolution Protocol (ARP) proxy function that, in effect, directs all upstream traffic to the IP gateway. MacFF also ensures layer-2 separation if a station attempts to obtain direct Ethernet connectivity to another station within the same IP subnet, but located at another end-user premise.

With MacFF, traffic between individual end-users is isolated over the Ethernet access network. Traffic always goes between the end-user device and the access router, never directly between end-user devices on different premises. IP addresses may be assigned to end-users both dynamically, via Dynamic Host Configuration Protocol (DHCP), and statically. It is not required to have individual IP subnets for each end-user network. IP over Ethernet is used as the access protocol to ensure an efficient multicast architecture and support for adequate QoS mechanisms. Notably, VLANs are not used to separate traffic pertaining to individual end-users, due to scalability and provisioning issues.

With MacFF, an Ethernet Access Node (EAN) ensures that upstream traffic is always sent to the designated access router, even if the IP traffic goes between end-users located in the same IP subnet. Initially, the EAN obtains a corresponding IP and MAC address of the target access router. The access router is typically the default gateway of the host, and the EAN may learn the IP address of the access router in one of two ways, depending on the host IP address assignment method. If the host uses DHCP, the access router IP address is dynamically learned by snooping the DHCP reply towards the host. Otherwise, the access router IP address is pre-provisioned by the network operator. In both cases, the EAN resolves the corresponding MAC address, using ARP. This can be done immediately after the IP address is learned, or when the MAC address is first required. An access network may contain multiple access routers, and different hosts may be assigned different access routers. Thus, the EAN must register the access router address on a per-user basis. Thereafter, the EAN replies with this MAC address to any upstream ARP request from end-user devices. The EAN also filters out any upstream traffic to MAC addresses other than the target access router.

With MacFF, end-users are not assigned individual IP subnets. In other words, several hosts located at different premises share an IP subnet. Consequently, if a host wishes to communicate with a host on another premise, an ARP request is issued to obtain the corresponding MAC address. This ARP request is intercepted by the EAN's ARP proxy, and is responded to with an ARP reply, indicating the access router MAC address as the requested layer-2 destination. In this way, the ARP table of the requesting host will register the access router MAC address as the layer 2 destination for any host within that IP subnet. An exception is made when a host is ARPing for another host located within the same premise. If this ARP request reaches the EAN, it is discarded, because it is assumed to be answered directly by a host locally within the premise.

Since the EAN's ARP proxy always replies with the MAC address of the access router, the requesting host never learns the MAC addresses of hosts located at other premises. However, malicious end-users or malfunctioning hosts may still try to send traffic using other destination MAC addresses. This traffic is discarded by the EAN. Traffic between hosts within the same IP subnet, but located at different premises is always sent via an IP Gateway. In this case, the access router forwards the traffic to the originating network, i.e., through the same interface from which it was received. This normally results in an Internet Control Message Protocol (ICMP) redirect message being sent to the originating host. To prevent this behavior, the ICMP redirect function is disabled in the access router.

One problem with the above solution is that VLAN+MacFF must be supported throughout the entire broadband access network. Specifically, the network device closest to the end user, such as an IP DSLAM or an Ethernet switch connected to the Customer Premises Equipment (CPE), must support MacFF, which is currently a proprietary solution. However, it is likely that the broadband access network is owned by at least two independent parties: an incumbent operator that owns the aggregation network and a number of last-mile owners that own last-mile networks to the end users. The aggregation network may use the VLAN+MacFF Public Ethernet solution, but the last-mile networks may use standard off-the-shelf switches that support only the standard VLAN solution. In order to provide multiple services to end users in this case, the last-mile network owners would be required to change their devices to support the proprietary MacFF solution. This would add both investment and maintenance cost, and the last-mile network owners may not be willing to do that.

### SUMMARY OF THE INVENTION

A remote access network scenario may be decomposed into a subscriber line part and an aggregation network part. The subscriber line, often referred to as “the last mile”, is characterized by an individual physical connection to each end-user premise. The aggregation network performs aggregation and concentration of end-user traffic. The subscriber line and the aggregation network are separated by an access node, a layer-2 entity which is referred to herein as a VLAN Mapping Point. Thus, the VLAN Mapping point constitutes the border between two independently tagged VLAN regions: the aggregation network and the individual subscriber lines (the last-mile network).

The present invention uses a mechanism called VLAN mapping together with the VLAN+MacFF Public Ethernet solution to provide multiple services to end users connected via last-mile networks. VLAN mapping is implemented in the VLAN Mapping Point. The VLAN Mapping Point provides two physical VLAN (802.1Q) trunks, one connected to each VLAN region. The VLAN Mapping Point includes a mapping function that enables hosts on one VLAN region, with a first set of VLAN ID assignments, to communicate with the other VLAN region, which may have a second, different set of VLAN ID assignments. The mapping function may be utilized to translate VLAN-per-service assignments in one region, to VLAN-per-user-per-service assignments in the other region according to predefined rules.

Thus, in one aspect, the invention is directed to a method of providing multiple simultaneous services through a single broadband connection to an end user when the end user is connected to a core network through first and second independently tagged VLAN regions. The method includes implementing a VLAN Mapping Point at a border between the first and second VLAN regions, with the first VLAN region being on a first side of the VLAN Mapping Point toward the end user, and the second VLAN region being on a second side of the VLAN Mapping Point toward the core IP network. The method also includes the steps of receiving in the VLAN Mapping Point, an upstream traffic packet from the first VLAN region, and upon receiving the upstream packet, mapping a VLAN tag for the first VLAN region to a VLAN tag for the second VLAN region. The VLAN Mapping Point then forwards the upstream traffic packet to the core IP network using the VLAN tag for the second VLAN region. The method also includes receiving in the VLAN Mapping Point, a downstream traffic packet from the second VLAN region, and upon receiving the downstream packet, mapping a VLAN tag for the second VLAN region to a VLAN tag for the first VLAN region. The VLAN Mapping Point then forwards the traffic to the end user using the VLAN tag for the first VLAN region.

In another aspect, the invention is directed to a VLAN Mapping Point implemented at a border between first and second independently tagged VLAN regions, wherein the first VLAN region is on a first side of the VLAN Mapping Point toward an end user, and the second VLAN region is on a second side of the VLAN Mapping Point toward a core IP network. The VLAN Mapping Point includes a first interface for receiving upstream traffic packets from the first VLAN region, and for sending downstream traffic packets to the first VLAN region; a second interface for receiving downstream traffic packets from the second VLAN region, and for sending upstream traffic packets to the second VLAN region; and a mapping function connected to the first and second interfaces. Upon receiving from the first interface, an upstream traffic packet that includes a VLAN tag for the first VLAN region, the mapping function maps the VLAN tag for the first VLAN region to a VLAN tag for the second VLAN region and sends the mapped upstream traffic packet to the second interface. Upon receiving from the second interface, a downstream traffic packet that includes a VLAN tag for the second VLAN region, the mapping function maps the VLAN tag for the second VLAN region to a VLAN tag for the first VLAN region, and sends the mapped upstream traffic packet to the second interface.

In yet another aspect, the invention is directed to a method of mapping Ethernet traffic packets between first and second independently tagged VLAN regions. The method includes the steps of implementing a VLAN Mapping Point at a border between the first and second VLAN regions, wherein the VLAN Mapping Point includes a mapping function that associates VLAN tags for each of the VLAN regions with VLAN tags for the other VLAN region. This is followed by receiving in the VLAN Mapping Point, a traffic packet from the first VLAN region that includes a VLAN tag for the first VLAN region. Upon receiving the traffic packet from the first VLAN region, the VLAN Mapping Point maps the VLAN tag for the first VLAN region to an associated VLAN tag for the second VLAN region, and forwards the traffic packet to the second VLAN region using the VLAN tag for the second VLAN region. Upon receiving in the VLAN Mapping Point, a traffic packet from the second VLAN region, the VLAN Mapping Point maps the VLAN tag for the second VLAN region to a VLAN tag for the first VLAN region, and forwards the traffic to the first VLAN region using the VLAN tag for the first VLAN region.

In still yet another aspect, the invention is directed to a method of providing multiple simultaneous services through a single broadband connection to an end user, when the end user is connected to a core network through first and second independently tagged VLAN regions. The method includes implementing an access node at a border between the first and second VLAN regions, wherein the first VLAN region is on a first side of the access node toward the end user, and the second VLAN region is on a second side of the access node toward the core network. The method also includes separating, in the second VLAN region, traffic from multiple end users, by implementing an Address Resolution Protocol (ARP) proxy function in the access node that ensures that upstream traffic packets from the first VLAN region are always sent to a designated access router. The method also includes mapping by the access node, VLAN tags received in upstream traffic packets to VLAN tags for the second VLAN region; and mapping by the access node, VLAN tags in downstream traffic packets received from the second VLAN region to VLAN tags for the first VLAN region.

### BRIEF DESCRIPTION OF THE DRAWINGS

In the following, the essential features of the invention will be described in detail by showing preferred embodiments, with reference to the figures of the attached drawings.

FIG. 1 is a simplified block diagram illustrating a network configuration for connecting end users to services in a core network according to an embodiment of the present invention;

FIG. 2 is a flow chart illustrating the steps of the method of the present invention when the VLAN Mapping Point maps downstream traffic;

FIG. 3 is a flow chart illustrating in more detail, the mapping process performed by the VLAN Mapping Point for downstream traffic; and

FIG. 4 is a flow chart illustrating the steps of the method of the present invention when the VLAN Mapping Point maps upstream traffic.

### DETAILED DESCRIPTION OF THE INVENTION

In the following description, for purposes of explanation and not limitation, specific details are set forth, such as particular embodiments, circuits, signal formats etc. in order to provide a thorough understanding of the present invention. It will be apparent to one skilled in the art that the present invention may be practiced in other embodiments that depart from these specific details. It should be noted, for example, that although the present invention is described in terms of a solution utilizing VLAN mapping plus MacFF, VLAN mapping is not limited to use with MacFF. Other service separation methods in the aggregation network can also be used together with VLAN mapping for multi-service provisioning.

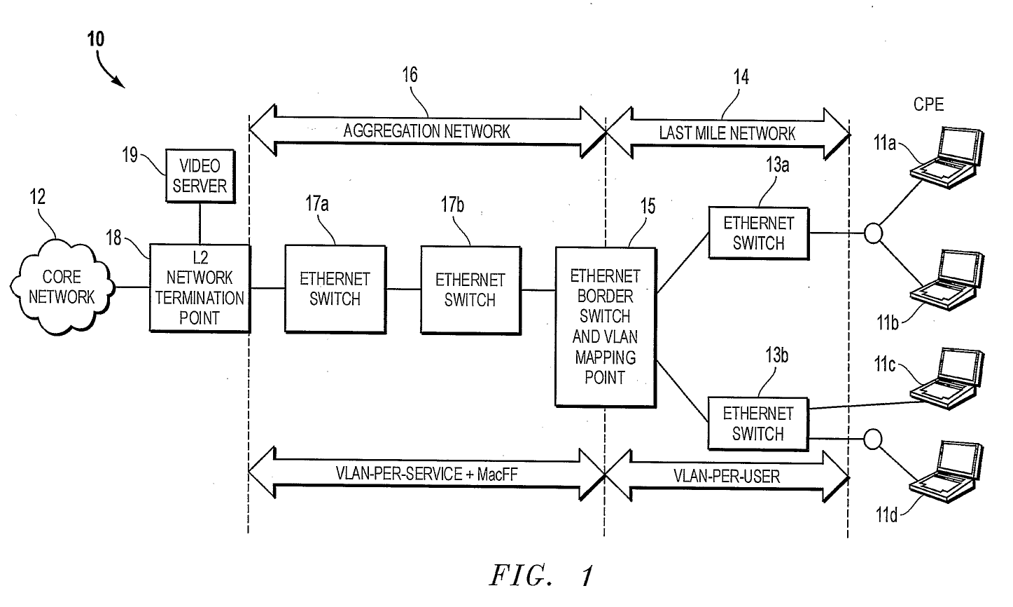

FIG. 1 is a simplified block diagram illustrating a network configuration 10 for enabling end users utilizing Customer Premises Equipment (CPE) 11a-11d to access services in a core network 12 according to an embodiment of the present invention. The end users connect through Ethernet switches 13a-13b located in a last-mile network 14. The last-mile Ethernet switches connect through an Ethernet border switch and VLAN Mapping Point 15 at the border between the last-mile network and an aggregation network 16. The aggregation network may include a number of Ethernet switches such as Ethernet switches 17a-17b, which connect the VLAN Mapping Point 15 to an Ethernet/Layer 2 network termination point 18 (for example, a Broadband Remote Access Server (BRAS)) between the aggregation network and the core network 12. The core network may be, for example, an IP core network, an optical transport network, a Multi-Protocol Label Switching (MPLS) network, a Metro Ethernet Network, and the like. Additionally, a server such as a video server 19 may be connected directly to the termination point 18.

The embodiment described herein is based on the assumption that VLAN-per-user-per-service is used in the last-mile network 14, and VLAN-per-service and MacFF is used in the aggregation network 16. For this to work, the Ethernet border switch and VLAN Mapping Point 15, at the border between the last-mile network and the aggregation network, must include functionality for mapping VLAN-per-service to VLAN-per-user-per-service, and vice versa (i.e., a “VLAN mapping” function). The VLAN Mapping Point may be used together with MacFF, although it is not limited to MacFF only.

By using VLAN-per-user-per-service in the last-mile network 14, switches 13a and 13b can be off-the-shelf switches. No proprietary mechanism such as MacFF is needed. In the aggregation network 16, the VLAN+MacFF Public Ethernet solution may be used, with the MacFF mechanism forcing upstream traffic to the L2 termination point 18. Using VLAN-per-user-per-service in the last-mile network also protects the aggregation network from being flooded by potential broadcast traffic generated within the last-mile network. If one user is simultaneously subscribing to services from several service providers, one VLAN-per-user-per-service is set up for each service provider.

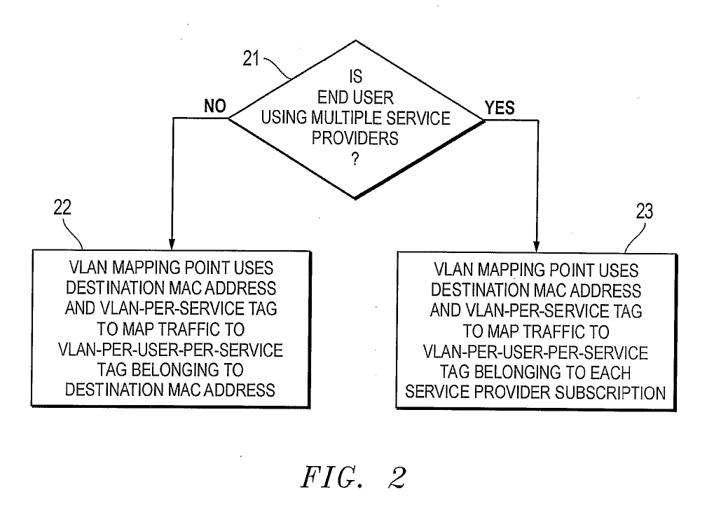

FIG. 2 is a flow chart illustrating the steps of the method of the present invention when the VLAN Mapping Point 15 maps downstream traffic (i.e., traffic flowing from the L2 termination point 18 toward the end user 11). The VLAN Mapping Point 15 performs its mapping according to defined VLAN mapping rules. At step 21, it is determined whether the end user is simultaneously using services from multiple service providers. If not, the method moves to step 22 where the VLAN Mapping Point uses a destination MAC address for the end user and possibly a VLAN-per-service tag from the aggregation network 16 to map the traffic to the VLAN-per-user-per-service tag belonging to that MAC address. However, if the end user is simultaneously using services from multiple service providers, the method moves instead to step 23 where the VLAN Mapping Point uses the destination MAC address for the end user and possibly the VLAN-per-service tag from the aggregation network 16 to map the traffic to the VLAN-per-user-per-service tag belonging to each service provider subscription.

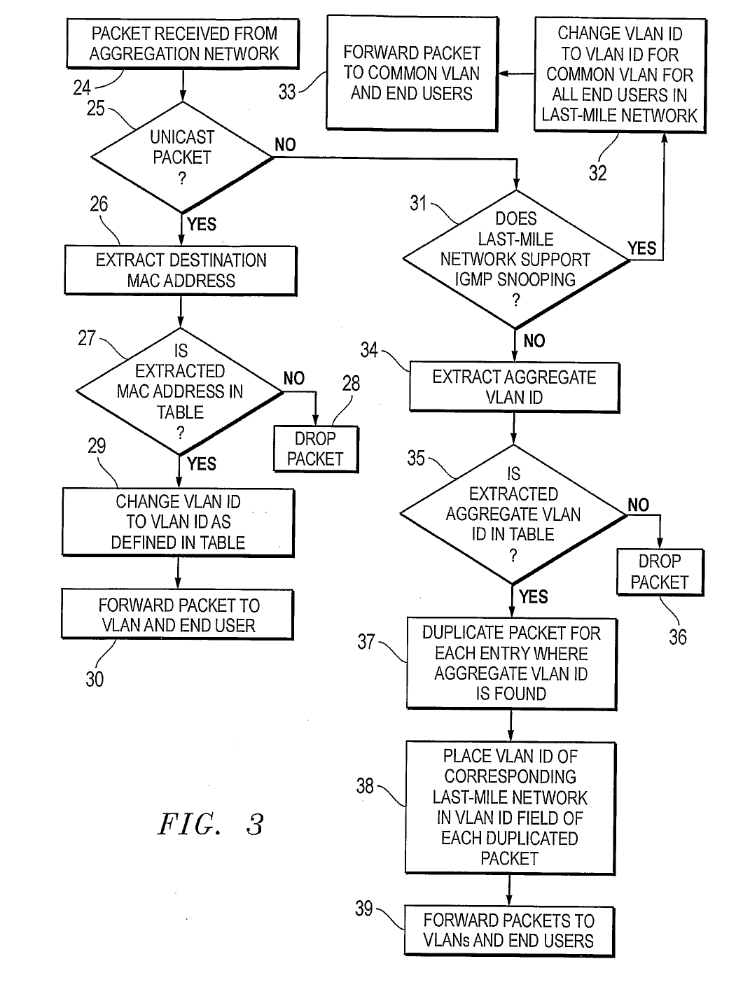

FIG. 3 is a flow chart illustrating in more detail, the mapping process performed by the VLAN Mapping Point 15 for downstream traffic. A downstream VLAN mapping algorithm in the VLAN Mapping Point includes rules that govern traffic in the downstream direction. At step 24, the VLAN Mapping Point receives a packet from the aggregation network 16. At step 25, it is determined whether the received packet is a unicast packet. If so, the destination Ethernet MAC address is extracted at step 26. The VLAN Mapping Point then accesses a rule-table at step 27 to determine whether the extracted MAC address is present. If not, the packet is dropped/discarded at step 28. If the extracted MAC address is present in the rule-table, the method moves to step 29 where the VLAN ID in the packet is changed to a VLAN ID as defined in the rule-table. At step 30, the VLAN Mapping Point forwards the packet to the identified VLAN and end user 11 utilizing the VLAN ID from the table.

If it is determined at step 25, however, that the packet received from the aggregation network is not a unicast packet (i.e., the packet is a multicast/broadcast (manycast) packet such as a packet for TV distribution), the method moves to step 31 where it is determined whether the last-mile network supports Internet Group Membership Protocol (IGMP) snooping. If so, the downstream traffic can be handled by using a single common VLAN for all residential users in the last-mile network. Therefore, at step 32, the VLAN ID in the received packet is changed to the VLAN ID for the common VLAN. At step 33, the packet is then forwarded to the common VLAN and the end users 11. Alternatively, the multicast traffic may simply be broadcast in the last-mile network.

However, if it is determined at step 31 that the last-mile network does not support IGMP snooping, the method moves to step 34 where an aggregate VLAN ID is extracted. The rule-table is then scanned at step 35 to determine whether the aggregate VLAN ID is present. If the aggregate VLAN ID is not in the table, the manycast packet is dropped/discarded at step 36. However, if the aggregate VLAN ID is found in the table, the method moves to step 37 where the packet is duplicated for each entry where the aggregate VLAN ID is found. At step 38, the VLAN ID of corresponding last-mile networks, as defined in the rule-table, are placed in the VLAN ID field of the duplicated manycast packets. At step 39, the packets are transmitted out of VLAN Mapping Point toward the VLANs and end users 11.

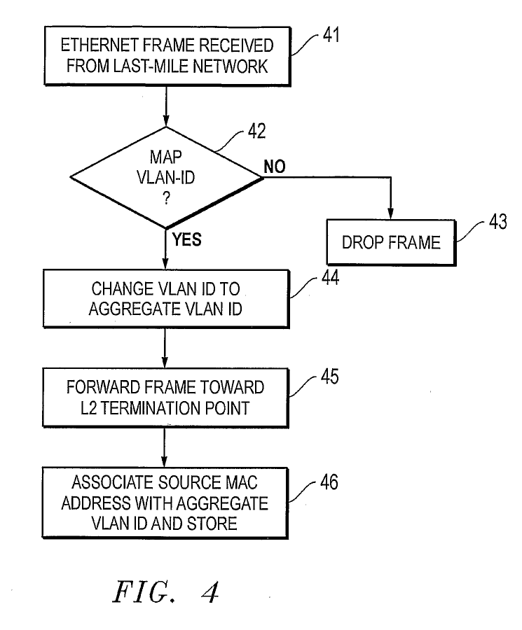

FIG. 4 is a flow chart illustrating the steps of the method of the present invention when the VLAN Mapping Point 15 maps upstream traffic (i.e., traffic flowing from the end user 11 toward the L2 termination point 18). For upstream traffic, the VLAN Mapping Point 15 uses the VLAN-per-user-per-service tag and the source MAC address (or alternatively, the VLAN-per-user-per-service and ingress port) to map the traffic into the correct VLAN-per-service (i.e., VLAN-per-user-per-service-per-service).

An upstream VLAN mapping algorithm includes rules that are (user) specified for traffic in the upstream direction. At step 41, the VLAN Mapping Point 15 receives an Ethernet frame from the last-mile network side where the end users reside. At step 42, the VLAN Mapping Point looks up the rule-table to determine whether the VLAN ID in the received frame should be mapped. If there is no rule, the method moves to step 43 where the Ethernet frame is not forwarded toward the L2 termination point, and the frame is dropped (i.e., discarded). If there is a rule, the method moves to step 44 where the VLAN ID is changed to an aggregate VLAN ID as per the rule. At step 45, the frame is then forwarded toward the L2 termination point 18 with this new aggregate VLAN ID. When a frame is forwarded, the VLAN Mapping Point associates the source MAC address of the frame with the aggregate VLAN ID and stores this information at step 46. This association is used by the VLAN Mapping Point to properly map the aggregate VLAN ID to the MAC address when downstream traffic addressed to the MAC address is received.

Untagged upstream traffic must either be tagged in the CPE or at the first point of traffic aggregation. The same node is also responsible for untagging tagged downstream traffic to end-user equipment that does not support VLAN.

The present invention provides distinct advantages regarding multi-service provisioning. The VLAN mapping enables a service provider to offer multiple services with different QoS requirements over a third-party last-mile network that includes only standard-compliant, VLAN-enabled switches. In addition, VLAN mapping also enables multiple service providers, operating through the same aggregation network and last-mile network, to provide services to the same end user. For example, end users can have one home PC surfing the Internet using one ISP, and another home PC simultaneously playing an interactive video game from another ISP.

The present invention also provides superior scalability when compared to other proposed solutions. All 4096 VLAN tags can be used in the aggregation network, and 4096 VLAN tags are available for each downstream port at the VLAN mapping point (assuming a tree structure below this point) . This means that if no meshed topology is used, the solution will scale up to 4096 times the number of downsteam ports at the VLAN mapping point. For example, with 24 ports, 4096×24 ports=98304 VLANs are available for use in the last-mile network. With good network planning, the solution can thus scale enough to connect most last-mile networks.

Traffic separation is done using VLAN-per-user-per-service and MacFF that forces upstream traffic to the L2 network termination point 18. Thus security is enhanced because no traffic can go directly between two end users within the access network without first passing the termination point 18. MacFF utilizes Virtual MACs, and when combined with the VLAN-per-user-per-service traffic separation, sufficient security is provided. The traffic separation using VLANs also allows service providers to run any IP-address plans without any interference with their competitors.

Similar to the VLAN+MacFF solution, DHCP Option 82 can be used to trace users. Since VLAN-per-user-per-service is used in the last-mile network, DHCP Option 82 can be implemented at the VLAN mapping point and does not have to be supported by the last-mile network switches. Some disadvantages are that DHCP Option 82 is less scalable and requires more complex configuration in the network. In addition, MacFF and VLAN mapping have to be implemented on more powerful switches because the functionality is more centrally located where the traffic is expected to be heavier.

The present invention provides a good alternative to Point-to-Point Protocol over Ethernet (PPPoE). Furthermore, it provides a more cost effective solution than the VLAN+MacFF solution because proprietary mechanisms are moved to a more centralized location, thereby allowing low cost off-the-shelf switches to be used further out in the network.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

1-14. (canceled)

15. A method of providing multiple simultaneous services through a single broadband connection to an end user, said end user being connected to a core network through first and second independently tagged Virtual Local Area Network (VLAN) regions, said method comprising the steps of:
implementing a VLAN Mapping Point at a border between the first and second VLAN regions, wherein the first VLAN region is on a first side of the VLAN Mapping Point toward the end user, and the second VLAN region is on a second side of the VLAN Mapping Point toward the core network;
receiving in the VLAN Mapping Point, an upstream traffic packet from the first VLAN region;
upon receiving the upstream packet:
mapping in the VLAN Mapping Point, a VLAN tag for the first VLAN region to a VLAN tag for the second VLAN region; and
forwarding the upstream traffic packet to the core network using the VLAN tag for the second VLAN region;
receiving in the VLAN Mapping Point, a downstream traffic packet from the second VLAN region;
upon receiving the downstream packet:
mapping in the VLAN Mapping Point, a VLAN tag for the second VLAN region to a VLAN tag for the first VLAN region; and
forwarding the traffic to the end user using the VLAN tag for the first VLAN region.

16. The method of claim 15, wherein the step of mapping a VLAN tag for the first VLAN region to a VLAN tag for the second VLAN region includes the steps of:
obtaining the VLAN tag for the second VLAN region from a table in the VLAN Mapping Point; and
replacing a VLAN ID in the upstream traffic packet with the VLAN tag for the second VLAN region.

17. The method of claim 16, wherein the step of mapping a VLAN tag for the second VLAN region to a VLAN tag for the first VLAN region includes the steps of:
obtaining the VLAN tag for the first VLAN region from a table in the VLAN Mapping Point; and
replacing a VLAN ID in the downstream traffic packet with the VLAN tag for the first VLAN region.

18. The method of claim 17, wherein the step of obtaining the VLAN tag for the first VLAN region from a table in the VLAN Mapping Point includes the steps of:
determining whether the downstream traffic packet is a unicast packet or a multicast packet;
upon determining that the downstream traffic packet is a unicast packet, extracting a destination Media Access Control (MAC) address from the unicast downstream packet; and
obtaining the VLAN tag for the first VLAN region from the table by matching the extracted MAC address to a corresponding VLAN tag for the first VLAN region.

19. The method of claim 17, wherein the step of obtaining the VLAN tag for the first VLAN region from a table in the VLAN Mapping Point includes the steps of:
determining whether the downstream traffic packet is a unicast packet or a multicast packet;
upon determining that the downstream traffic packet is a unicast packet, extracting from the unicast downstream packet, a destination Media Access Control (MAC) address and the VLAN tag for the second VLAN region; and
obtaining the VLAN tag for the first VLAN region from the table by matching the extracted MAC address and the VLAN tag for the second VLAN region to a corresponding VLAN tag for the first VLAN region.

20. The method of claim 18, wherein the step of obtaining the VLAN tag for the first VLAN region from a table in the VLAN Mapping Point also includes the step of:
upon determining that the downstream traffic packet is a multicast packet, obtaining from the table, a common VLAN tag for all end users in the first VLAN region.

21. The method of claim 18, wherein the step of obtaining the VLAN tag for the first VLAN region from a table in the VLAN Mapping Point also includes the steps of:
upon determining that the downstream traffic packet is a multicast packet, extracting an aggregate VLAN tag from the multicast downstream packet;
determining a number of entries in the table for which VLAN tags for the first VLAN region are associated with the extracted aggregate VLAN tag, and
duplicating the downstream traffic packet for each of the entries in the table for which a VLAN tag for the first VLAN region is associated with the extracted aggregate VLAN tag;
wherein the VLAN Mapping Point changes the VLAN ID in each of the duplicated downstream traffic packets to include a different one of the associated VLAN tags for the first VLAN region, and forwards the duplicated downstream traffic packets to end users using the associated VLAN tags for the first VLAN region.

22. The method of claim 15, wherein the first VLAN region is a last-mile network connecting the end user to the VLAN Mapping Point, and the second VLAN region is an aggregation network connecting a Layer 2 termination point to the VLAN Mapping Point.

23. The method of claim 22, wherein the VLAN tag for the first VLAN region is a VLAN-per-user-per-service tag, and the VLAN tag for the second VLAN region is a VLAN-per-service tag.

24. A Virtual Local Area Network (VLAN) Mapping Point implemented at a border between first and second independently tagged VLAN regions, wherein the first VLAN region is on a first side of the VLAN Mapping Point toward an end user, and the second VLAN region is on a second side of the VLAN Mapping Point toward a core network, said VLAN Mapping Point comprising:
a first interface for receiving upstream traffic packets from the first VLAN region, and for sending downstream traffic packets to the first VLAN region;
a second interface for receiving downstream traffic packets from the second VLAN region, and for sending upstream traffic packets to the second VLAN region; and
a mapping function connected to the first and second interfaces that, upon receiving from the first interface an upstream traffic packet that includes a VLAN tag for the first VLAN region, maps the VLAN tag for the first VLAN region to a VLAN tag for the second VLAN region, and sends the mapped upstream traffic packet to the second interface, and, upon receiving from the second interface a downstream traffic packet that includes a VLAN tag for the second VLAN region, maps the VLAN tag for the second VLAN region to a VLAN tag for the first VLAN region, and sends the mapped upstream traffic packet to the second interface.

25. The VLAN Mapping Point of claim 24, wherein the mapping function includes:
a mapping table that matches VLAN tags for the first VLAN region to associated VLAN tags for the second VLAN region; and
means for changing a VLAN ID in received traffic packets, said means for changing a VLAN ID replacing the VLAN ID in upstream traffic packets with the VLAN tag for the second VLAN region.

26. The VLAN Mapping Point of claim 25, wherein the mapping table also matches VLAN tags for the second VLAN region to associated VLAN tags for the first VLAN region, and the means for changing a VLAN ID in a received traffic packet also reolaces the VLAN ID of downstream traffic packets with the VLAN tag for the first VLAN region.

27. The VLAN Mapping Point of claim 26, wherein the mapping function also includes:
means for determining whether a received downstream traffic packet is a unicast packet or a multicast packet;
means, responsive to determining that the downstream traffic packet is a unicast packet, for extracting a destination Media Access Control (MAC) address from the unicast downstream packet; and
means for obtaining the VLAN tag for the first VLAN region from the mapping table by matching the extracted MAC address to a corresponding VLAN tag for the first VLAN region.

28. The VLAN Mapping Point of claim 27, wherein the mapping function also includes:
means, responsive to determining that the downstream traffic packet is a multicast packet, for obtaining from the mapping table, a common VLAN tag for all end users in the first VLAN region.

29. The VLAN Mapping Point of claim 27, wherein the mapping function also includes:
means responsive to determining that the downstream traffic packet is a multicast packet, for extracting an aggregate VLAN tag from the multicast downstream packet;
means for determining a number of entries in the table for which VLAN tags for the first VLAN region are associated with the extracted aggregate VLAN tag; and
means for duplicating the downstream traffic packet for each of the entries in the table for which a VLAN tag for the first VLAN region is associated with the extracted aggregate VLAN tag;
wherein the VLAN Mapping Point replaces the VLAN ID in each of the duplicated downstream traffic packets with a different one of the associated VLAN tags for the first VLAN region, and forwards the duplicated downstream traffic packets to end users using the associated VLAN tags for the first VLAN region.

30. The VLAN Mapping Point of claim 24, wherein the first VLAN region is a last-mile network connecting the end user to the VLAN Mapping Point, and the second VLAN region is an aggregation network connecting a Layer 2 termination point to the VLAN Mapping Point.

31. The VLAN Mapping Point of claim 30, wherein the VLAN tag for the first VLAN region is a VLAN-per-user-per-service tag, and the VLAN tag for the second VLAN region is a VLAN-per-service tag.

32. A method of mapping Ethernet traffic packets between first and second independently tagged Virtual Local Area Network (VLAN) regions, said method comprising the steps of:
implementing a VLAN Mapping Point at a border between the first and second VLAN regions, said VLAN Mapping Point including a mapping function that associates VLAN tags for each of the VLAN regions with VLAN tags for the other VLAN region;
receiving in the VLAN Mapping Point, a traffic packet from the first VLAN region, said traffic packet from the first VLAN region including a VLAN tag for the first VLAN region;
upon receiving the traffic packet from the first VLAN region:
mapping in the VLAN Mapping Point, the VLAN tag for the first VLAN region to an associated VLAN tag for the second VLAN region; and
forwarding the traffic packet to the second VLAN region using the VLAN tag for the second VLAN region;
receiving in the VLAN Mapping Point, a traffic packet from the second VLAN region, said traffic packet from the second VLAN region including a VLAN tag for the second VLAN region; and
upon receiving the traffic packet from the second VLAN region:
mapping in the VLAN Mapping Point, the VLAN tag for the second VLAN region to a VLAN tag for the first VLAN region; and
forwarding the traffic to the first VLAN region using the VLAN tag for the first VLAN region.

33. The method of claim 32, wherein the first VLAN region is a last-mile network connecting the end user to the VLAN Mapping Point, and the second VLAN region is an aggregation network connecting a Layer 2 termination point to the VLAN Mapping Point.

34. The method of claim 33, wherein the VLAN tag for the first VLAN region is a VLAN-per-user-per-service tag, and the VLAN tag for the second VLAN region is a VLAN-per-service tag.

35. A method of providing multiple simultaneous services through a single broadband connection to an end user, said end user being connected to a core network through first and second independently tagged Virtual Local Area Network (VLAN) regions, said method comprising the steps of:
implementing an access node at a border between the first and second VLAN regions, wherein the first VLAN region is on a first side of the access node toward the end user, and the second VLAN region is on a second side of the access node toward the core network;
separating, in the second VLAN region, traffic from multiple end users, by implementing an Address Resolution Protocol (ARP) proxy function in the access node that ensures that upstream traffic packets from the first VLAN region are always sent to a designated access router;
mapping by the access node, VLAN tags received in upstream traffic packets to VLAN tags for the second VLAN region; and
mapping by the access node, VLAN tags in downstream traffic packets received from the second VLAN region to VLAN tags for the first VLAN region.

36. The method of claim 35, wherein the VLAN tags for the first VLAN region are VLAN-per-user-per-service tags, and the VLAN tags for the second VLAN region are VLAN-per-service tags.
